(19) United States
(12) Patent Application Publication
(10) Pub. No.: US 2026/0300871 A1
(43) Pub. Date: Oct. 1, 2026

(54) MULTIPARTITE ENTANGLEMENT FOR APPLICATION WORKFLOW WITH EARLY WARNING ACCORDANCE ALARM

(71) Applicant: Bank of America Corporation, Charlotte, NC (US)

(72) Inventors: Saurabh Arora, Gurugram (IN); Meenatchi Natarajan, Tamil Nadu (IN); Sandeep Kumar Chauhan, Telangana (IN)

(21) Appl. No.: 19/095,394

(22) Filed: Mar. 31, 2025

(51) Int. Cl. G06Q 10/0633; G06N 10/80

(52) U.S. Cl. CPC G06Q 10/0633; G06N 10/80

(57) ABSTRACT

Aspects of the disclosure relate to a quantum computing based real-time alert and notification system. A quantum computing notification platform utilizing quantum entanglement may be integrated with a workflow processing platform and configured to provide real-time alerts to all components of a workflow.

### BACKGROUND

Current workflow and application-based systems using multiple components may wait for upstream components to execute their tasks before processing their own workstreams. This waiting leads to overall processing delays. Moreover, for critical workflows where a step that is in process and needs to stop or is delayed due to failure or alarm incurring in a previous component may lead to errors in downstream components. Such errors may include invalid fund transfers, incorrect files being processed, and/or inappropriate credit request approvals. These workflow stoppages or processing delays may also lead to incorrect communications being transmitted to users or other systems. Any incorrect communication needs to be quickly corrected and retransmitted adding additional processing time and overall processing costs.

For instance, a typical credit workflow is an iterative process in which a financial system determines and uses information such as borrower's, co-borrower’s and guarantor’s credit score details, deposit details, and payment history to make credit decisions. Determining and communicating changes in these information categories to all application-based system components involved in the credit determination workflow in a timely manner is important for accurate credit approval determinations. However, in current credit workflows indicators are passed through APIs or batch files which may take time to deliver and can sometimes be delivered after few attempts in case of failures. This late notifications of changes in these information categories may lead to inaccurate credit determinations.

Groups of components where a decision from one component might trigger critical flows, should have timely updated inputs from all related or dependent systems. Cohesive integrity across different applications or sub-components from one application ensures there is no communication delay.

### SUMMARY

Aspects of the disclosure provide effective, efficient, scalable, fast, reliable, and convenient technical solutions that address and overcome the technical problems associated with quantum computing based real-time notification system

The disclosure relates to a quantum computing based real-time alert and notification system. A quantum computing notification platform utilizing quantum entanglement may be integrated with a workflow processing platform and configured to provide real-time alerts to all components of a workflow.

In an embodiment of the disclosure, a computing platform such as a quantum computing notification may monitor states from multiple objects/application component/workflow elements at the same time and may reflect any changes in any of the component/workflow elements. For example, the quantum computing notification platform may bind each workflow state in a way that all updates in a workflow states are immediately reflected to all components in the workflow process.

In one exemplary embodiment, an early warning accordance alarm may be configured to alert all components of the workflow in real-time. In another aspect of the disclosure, the quantum computing notification platform may maintain a composite quantum state among all components.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for a quantum computing based real-time notification system in accordance with one or more aspects described herein;

FIG. 2 depicts an illustrative related art diagram of a credit workflow in accordance with one or more aspects described herein;

FIGS. 3 and 4 depict illustrative diagrams for a quantum computing based real-time notification system in accordance with one or more aspects described herein; and

FIG. 5 depicts an illustrative method for quantum computing based real-time notification system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Enterprise organizations may deploy a workflow processing platform and a quantum computing notification platform to receive real-time notifications during an executing workflow process. Generally, it may important for an enterprise to receive real-time alerts to notify upstream and downstream components involved in the workflow process being executed.

However, due to a large volume of enterprise workflows, and a multitude of factors that may potentially impact each workflow, it may be a challenge for organizations to provide real-time alerts and notifications to all components involved in a workflow. For example, in some instances, downstream components may execute before being alerted by an upstream component that there may be a problem with a transaction. An inability to detect and notify in real-time other workflow components may pose challenges to a smooth functioning of the workflow processing platform. Accordingly, rapid detection and notification of problems within a workflow may be important for the enterprise organization. Accordingly, a quantum computing notification platform utilizing quantum entanglement may be integrated with a workflow process platform and configured to alert and notify components of a workflow of any real-time problems.

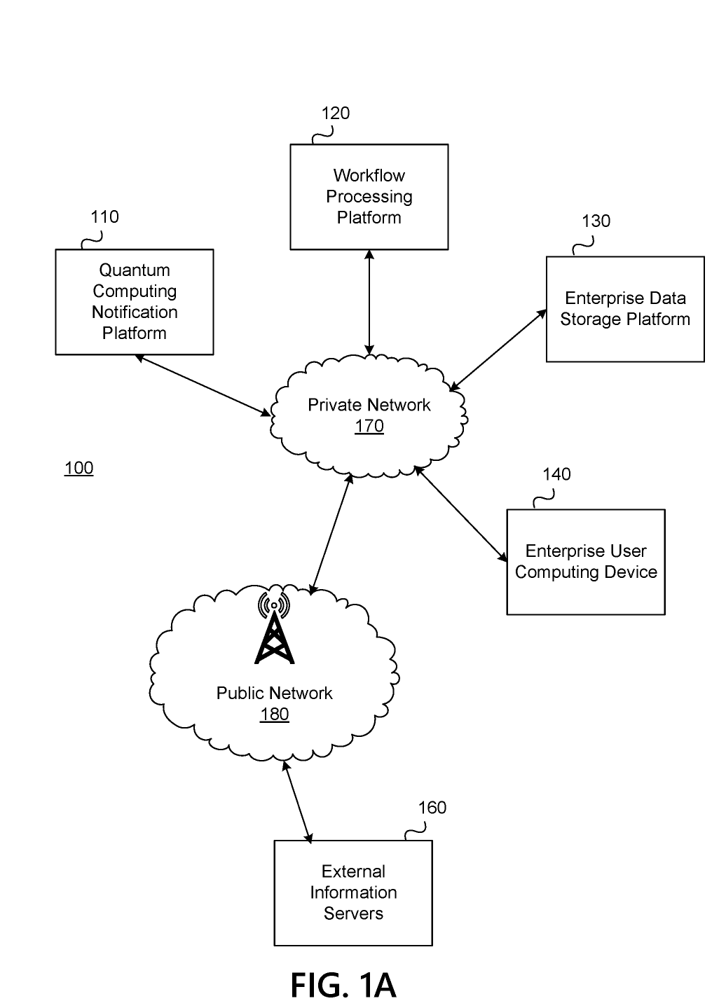

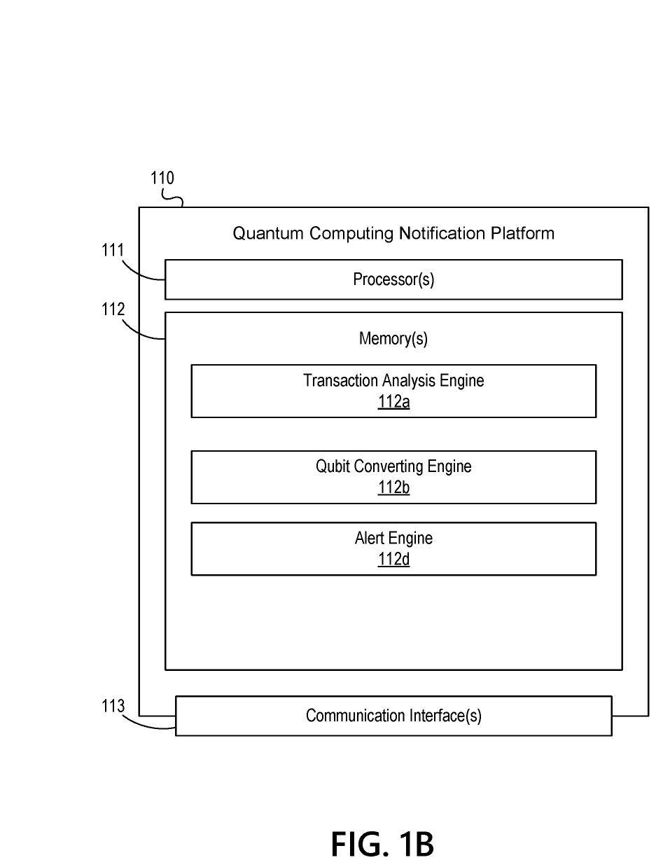

FIGS. 1A and 1B depict an illustrative computing environment including a quantum computing notification platform to provide real-time notifications. Referring to FIG. 1A, computing environment 100 may include one or more computer systems. For example, computing environment 100 may include a quantum computing notification platform 110, a workflow processing platform 120, an enterprise data storage platform 130, an enterprise user computing device 140, and external information servers 160.

As illustrated in greater detail below, quantum computing notification platform 110 may include one or more computing devices configured to perform one or more of the functions described herein. For example, quantum computing notification platform 110 may include one or more computers (e.g., laptop computers, desktop computers, servers, server blades, or the like) and/or other computer components (e.g., processors, memories, communication interfaces). In particular, quantum computing notification platform 110 may be configured to perform operations based on quantum computing, and to generate, manipulate, modify, and/or sequence of quantum bits.

Workflow processing platform 120 may include one or more computing devices and/or other computer components (e.g., processors, memories, communication interfaces). In addition, workflow processing platform 120 may be configured to host, execute, and/or otherwise provide one or more applications that process workflows. For example, workflow processing platform 120 may be configured to host, execute, and/or otherwise provide one or more applications, such as, for example, banking applications, trading applications, mortgage applications, business loan applications, and/or other applications associated with an enterprise organization. In some instances, workflow processing platform 120 may be configured to provide various enterprise and/or back-office computing functions for an enterprise organization. For example, workflow processing platform 120 may include various servers and/or databases that process and/or otherwise maintain business information, information associated with business processes, data from a plurality of external sources, and so forth. In addition, workflow processing platform 120 may process and/or otherwise execute actions based on scripts, commands and/or other information received from other computer systems included in computing environment 100. Additionally or alternatively, workflow processing platform 120 may receive instructions from quantum computing notification platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain information related to workflows. For example, enterprise data storage platform 130 may be configured to store and/or otherwise maintain data associated with a credit application transaction, a banking transaction, a trade related transaction, a loan transaction, and so forth. In addition, and as illustrated in greater detail below, enterprise data storage platform 130 may be configured to store and/or otherwise maintain quantum bits. Additionally or alternatively, workflow processing platform 120 may load data from enterprise data storage platform 130, manipulate and/or otherwise process such data, and return modified data and/or other data to enterprise data storage platform 130 and/or to other computer systems included in computing environment 100.

Enterprise user computing device 140 may be a personal computing device (e.g., desktop computer, laptop computer) or mobile computing device (e.g., smartphone, tablet, wearable device). In addition, enterprise user computing device 140 may be linked to and/or used by an employee of the enterprise organization that hosts quantum computing notification platform 110, perform one or more operations associated with workflow processing platform 120, such as, for example, reviewing, validating, and/or denying transactions.

External information servers 160 may include one or more computing devices and/or other computer components (e.g., processors, memories, communication interfaces). In addition, workflow processing platform 120 receive information for external information serves 160 such as third party credit scoring information, be configured to host, execute, and/or otherwise provide one or more data sources for information from LiDAR, traffic application programming interfaces (API), news feeds (e.g., social network, media network), and so forth. In some embodiments, external information servers 160 may be a personal computing device (e.g., desktop computer, laptop computer) or mobile computing device (e.g., smartphone, tablet, wearable device), that may be a source of information.

Computing environment 100 also may include one or more networks, which may interconnect one or more of quantum computing notification platform 110, workflow processing platform 120, enterprise data storage platform 130, enterprise user computing device 140, user device 150, and/or external information servers 160. For example, computing environment 100 may include a private network 170 (which may, e.g., interconnect quantum computing notification platform 110, workflow processing platform 120, enterprise data storage platform 130, enterprise user computing device 140, and/or one or more other systems which may be associated with an organization, and public network 180 (which may, e.g., interconnect user device 150, and/or external information servers 160 with private network 170 and/or one or more other systems, public networks, sub-networks, and/or the like). Public network 180 may be a cellular network, including a high generation cellular network, such as, for example, a 5G or higher cellular network. In some embodiments, private network 170 may likewise be a high generation cellular enterprise network, such as, for example, a 5G or higher cellular network.

In one or more arrangements, workflow processing platform 120, enterprise data storage platform 130, enterprise user computing device 140, user device 150, and/or external information servers 160, and/or the other systems included in computing environment 100 may be any type of computing device capable of receiving input via a user interface, and communicating the received input to one or more other computing devices. For example, workflow processing platform 120, enterprise data storage platform 130, enterprise user computing device 140, user device 150, and/or external information servers 160, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of quantum computing notification platform 110, workflow processing platform 120, enterprise data storage platform 130, enterprise user computing device 140, user device 150, and/or external information servers 160, may, in some instances, be special-purpose computing devices configured to perform specific functions.

Referring to FIG. 1B, quantum computing notification platform 110 may include one or more processors 111, memory 112, and communication interface 113. A data bus may interconnect processor 111, memory 112, and communication interface 113. Communication interface 113 may be a network interface configured to support communication between quantum computing notification platform 110 and one or more networks (e.g., network 160, network 170, a local network, or the like). Memory 112 may include one or more program modules having instructions that when executed by processor 111 cause quantum computing notification platform 110 to perform one or more functions described herein and/or one or more databases that may store and/or otherwise maintain information which may be used by such program modules and/or processor 111. In some instances, the one or more program modules and/or databases may be stored by and/or maintained in different memory units of quantum computing notification platform 110 and/or by different computing devices that may form and/or otherwise make up quantum computing notification platform 110. For example, memory 112 may have, store, and/or include a transaction analysis engine 112a, a qubit converting engine 112b, and an alert engine 112d.

Transaction analysis engine 112a may have instructions that direct and/or cause quantum computing notification platform 110 to receive, by a computing device and from a workflow processing platform, one or more features of a transaction by a user. In some embodiments, transaction analysis engine 112a may have instructions that direct and/or cause quantum computing notification platform 110 to retrieve, by the computing device and from a plurality of data sources, one or more attributes that may impact the transaction. In some embodiments, transaction analysis engine 112a may have instructions that direct and/or cause quantum computing notification platform 110 to identify, by the computing device and based on the transaction and the one or more attributes, a plurality of business rules applicable to the transaction.

Qubit converting engine 112b may have instructions that direct and/or cause quantum computing notification platform 110 to transform determined associated states within each determined workflow component into composite quantum states, the composite quantum states entangled within each other.

Alert engine 112d may have instructions that direct and/or cause quantum computing notification platform 110 to an alert components within a workflow of detected error. Alert engine 112d may also communicate any errors or delays in processing to the workflow processing platform.

Generally, an enterprise organization may deploy a workflow processing platform (e.g., workflow processing platform 120) to provide services to a user base hosting numerous applications.

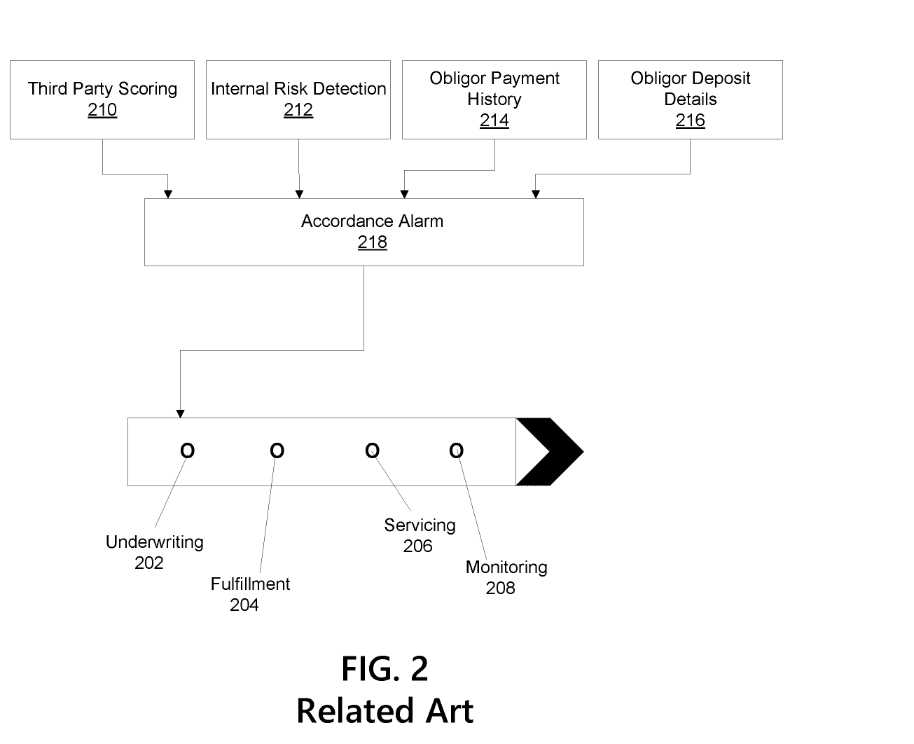

FIG. 2 depicts an illustrative related art diagram of a credit workflow. In FIG. 2, the sample credit workflow includes components such as underwriting 202, fulfillment 204, servicing 206, and monitoring 208. The credit workflow shown in FIG. 2 is a sequential workflow process where each component waits on the previous component to complete its workflow before executing its workflow. This introduces delay and latency into the process which may lead to invalid fund transfer, incorrect files being processed, and inappropriate credit approvals.

In FIG. 2, underwriting component 202 may utilize information from internal and external sources to accomplish its workflow. For instance, information sources such as third party scoring 210, internal risk detection 212, obligor payment history 214, and obligor deposit details 216 may be used by underwriting component 202 in determining credit approvals. Though each of the sources third party scoring 210, internal risk detection 212, obligor payment history 214, and obligor deposit details 216 may determine and provide information in parallel to underwriting 202, once the workflow progress to fulfillment any change or update in underwiring 202 may not be reflected in the later components such as fulfillment 204, servicing 206, and monitoring 208. Additionally, if underwriting component 202 should fail or be delayed in processing its later updated decision may not be reflected in the later workflow components leading to potential errors and/or problems.

In an embodiment of the disclosure, numerous additional workflows other than a credit workflow may be utilized with this disclosure. For instance, payment workflows, new account opening workflows, credit card issuance workflows, digital wallet provisioning workflows, digital wallet sales workflows, et al. may be used and are contemplated for use with the described embodiments of this disclosure.

Accordingly, proposed herein is a solution to the problems described above that includes representing the entire workflow as one entangled platform without latency. In one aspect of the disclosure, a computing platform such as a quantum computing notification platform 110 may monitor states from multiple objects/application component/workflow elements at the same time and can reflect any changes in any of the component/workflow elements. For example, the quantum computing notification platform 110 may bind each workflow state in a way that all updates in a workflow states are immediately reflected to all components in the workflow process.

In one exemplary embodiment, an early warning accordance alarm 300 may be configured to be fed from multiple components (alarms from one component needs trigger to other components to stop invalid processing). Logical points within workflow components are identified and certain states are defined that effect the process of other components. For example, each component such as third party scoring component 302, internal risk detection component 304, obligor payment history component 306, and obligor deposit details component 308 may be analyzed to determine the logical steps included in each of their related sub workflows. For instance, third party scoring 302 may include logical step 1 (310) through logical step 4 (316). Each component may contain numerous logical steps. In an embodiment, only specific action points within larger components may get entangled together for state changes.

In another aspect of the disclosure, the quantum computing notification platform 110 may maintain a composite quantum state among all components. The quantum computing notification platform 110 may break the state by passing the signals to all its sub nodes in all hierarchy levels without interrupting other processing within components as defined logical points may only be entangled.

The quantum computing notification platform 110 may be updated as needed to support large systems. The quantum computing notification platform 110 in large systems may execute actionable instances across multiple applications passing in data and inputs to others without any delay leading to accurate processing and avoiding issues occurring from delayed messaging.

The quantum computing notification platform 110 provides a method for multiple components being tied together for state reflections across each other. The entire workflow, irrespective of multiple applications within, may be considered one bundle without impacting individual component level capability. The early accordance alarm 300 of the quantum computing notification platform 110 reduces false positive confirmations for components to proceed thereby reducing errors and invalid transactions. The quantum computing notification platform 110 may ensure that logical steps are tagged to appropriate counterparts in the overall workflow.

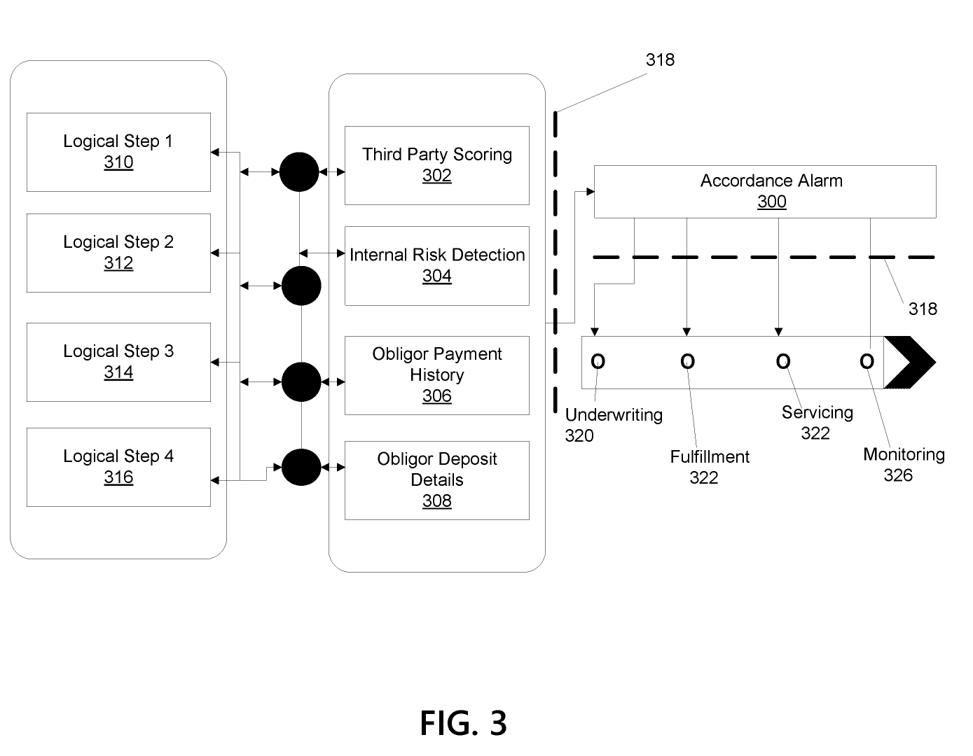

Returning to FIG. 3, multiple components such as underwriting component 320, fulfillment component 322, servicing component 324, and monitoring component 326 and their related state changes may be entangled 318 together to reflect state changes in the entangled components.

In some examples, the quantum computing notification platform 110 may comprise an artificial intelligence model, a quantum processing model, numerus workflow component and database i.e. (third party scoring component, internal risk component, obligor payment history database, and obligor deposit database). The quantum computing notification platform 110 may comprise a data request engine, a plurality of data queues, and/or a network engine. The quantum computing notification platform 110 may also comprise a quantum processor and/or a quantum analysis engine.

In some embodiments, a qubit converting engine 112b may transform determined associated states within each determined workflow component into composite quantum states, the composite quantum states entangled within each other. The qubit converting engine 112b may utilize quantum bits (qubits) for transforming the determined associated states into composite quantum states.

Generally, the term “quantum bit” or “qubit” as used herein, refers to a quantum version of a bit in classical computing. Like a classical bit may be in two states, “0” and “1”, a quantum bit may be in a linear combination of two orthogonal states denoted as “|0>” and “|1>.” However, when a quantum bit is measured, its physical manifestation may be in two discrete forms, that may be denoted as “|0>” and “|1>.” A qubit may be physically manifested in a variety of forms, such as, for example, polarizations of a photon, discrete energy levels of an ion, spin states of an electron, and so forth. Generally, 40 qubits may be encoded to represent approximately a trillion transactions.

As described herein, composite quantum states may be entangled. Generally the term “entanglement” as used herein refers to a high degree of correlation between two quantum states.

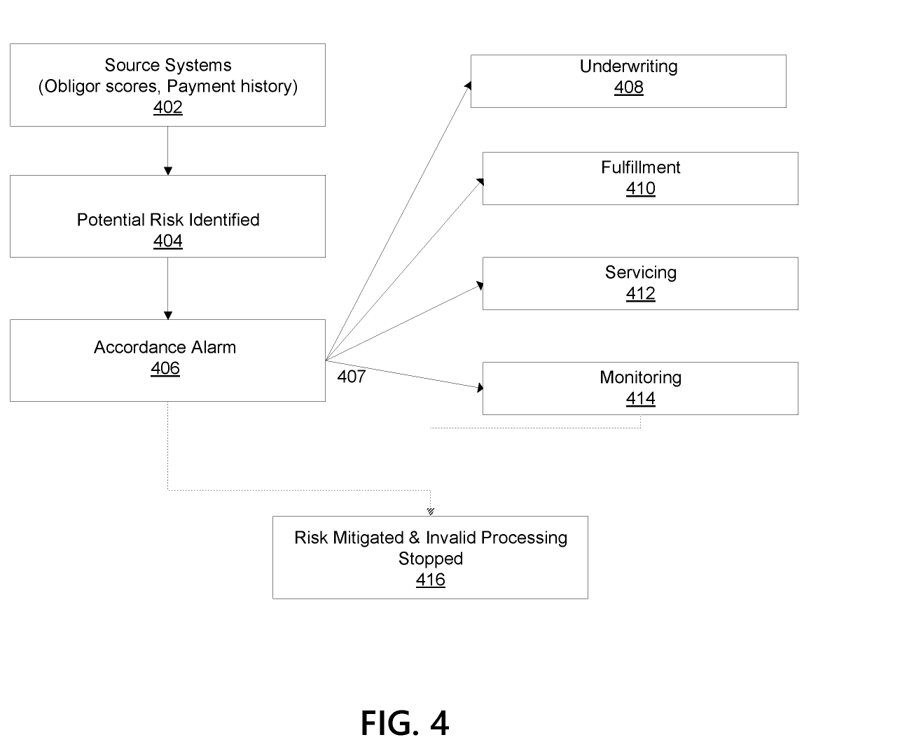

FIG. 4 illustrates a quantum computing based real-time notification alarm in accordance with one or more aspects described herein. As shown in FIG. 4, if a potential risk is identified 404 based on in part information received from source system 402, quantum computing notification platform 110 may activate an accordance alarm 406 which includes a parallel signal blast 407 to all components 408-414 associated with the workflow being executed. The parallel signal blast 407 occurs in real-time and may mitigate risk 416. In an embodiment, quantum computing notification platform 110 may also stop workflow processing due to an determined error.

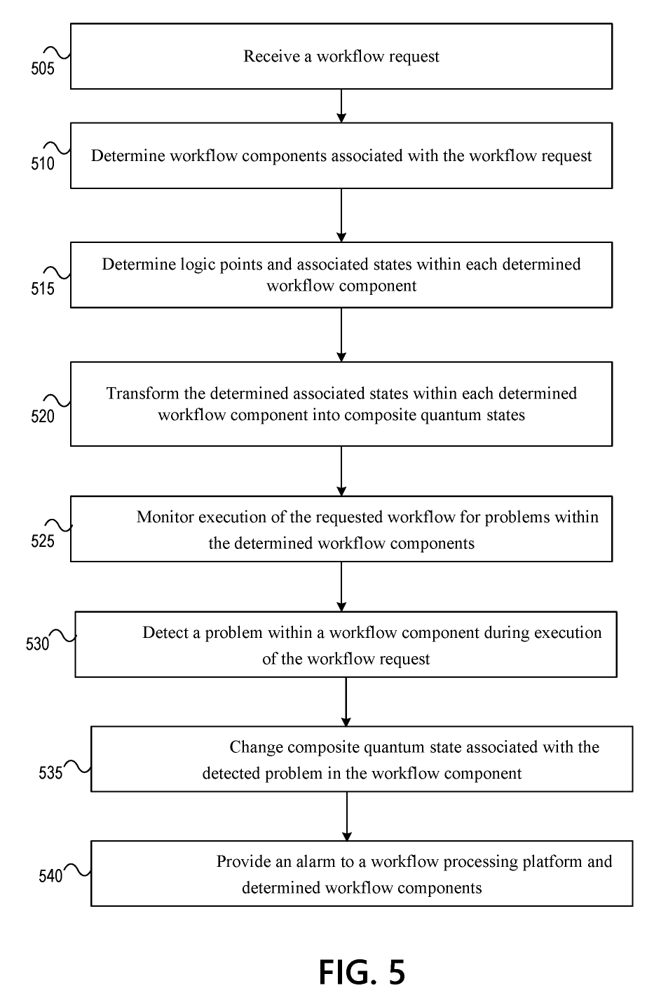

FIG. 5 depicts an illustrative method for a quantum computing based real-time notification system in accordance with one or more aspects described herein. In FIG. 5, a quantum computing notification platform 110 may in step 505 receive a workflow request. In step 510, quantum computing notification platform 110 may determine workflow components associated with the received workflow request. In step 515, quantum computing notification platform 110 may determine logic points and associated states within each determined workflow component associated with the received workflow request that effect other determined workflow components associated with the workflow request. Next, in step 520, quantum computing notification platform 110 may transform the determined associated states within each determined workflow component into composite quantum states, the composite quantum states entangled within each other. As shown in step 525, the workflow may be monitored for any problems within the determined workflow components. In step 530, quantum computing notification platform 110 may detect a problem within a workflow component during execution of the workflow request. Quantum computing notification platform 110, may in step 535 change a composite quantum state associated with the detected problem in the workflow component, the changed composite quantum state reflected in the each of the determined workflow components. In step 540, quantum computing notification platform 110 may provide an alarm to a workflow processing platform and determined workflow components.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor; and
memory storing computer-readable instructions that, when executed by the at least one processor, cause the computing platform to:
receive, a workflow request;
determine workflow components associated with the received workflow request;
determine logic points and associated states within each determined workflow component associated with the received workflow request that effect other determined workflow components associated with the workflow request;
transform the determined associated states within each determined workflow component into composite quantum states, the composite quantum states entangled within each other;
monitor execution of the requested workflow for problems within the determined workflow components;
detect a problem within a workflow component during execution of the workflow request;
change composite quantum state associated with the detected problem in the workflow component, the changed composite quantum state reflected in the each of the determined workflow components; and
provide an alarm to a workflow processing platform and determined workflow components.

2. The computing platform of claim 1, wherein the instructions comprise additional computer-readable instructions that, when executed by the at least one processor, cause the computing platform to stop execution of the workflow request in real-time based on the changed composite quantum state.

3. The computing platform of claim 1, wherein the instructions comprise additional computer-readable instructions that, when executed by the at least one processor, cause the computing platform to determine workflow components associated with additional workflows, the determined workflow components used in both the additional workflows and the requested workflow.

4. The computing platform of claim 3, wherein the instructions comprise additional computer-readable instructions that, when executed by the at least one processor, cause the computing platform to determine logic points and associated states within each determined additional workflow component that effect other determined workflow components associated with the additional workflows.

5. The computing platform of claim 4, wherein the instructions comprise additional computer-readable instructions that, when executed by the at least one processor, cause the computing platform to transform the determined associated states within each determined additional workflow component into composite quantum states.

6. The computing platform of claim 1, wherein the requested workflow comprises a credit workflow.

7. The computing platform of claim 6, wherein the requested credit workflow includes an underwriting component, a fulfillment component, a servicing component, and a monitoring component.

8. The computing platform of claim 1, wherein the requested workflow comprises an account opening workflow.

9. The computing platform of claim 1, wherein the requested workflow comprises a digital wallet provisioning workflow.

10. A method, comprising:
at a computing platform comprising at least one processor, and memory:
receiving, a workflow request;
determining workflow components associated with the received workflow request;
determining logic points and associated states within each determined workflow component associated with the received workflow request that effect other determined workflow components associated with the workflow request;
transforming the determined associated states within each determined workflow component into composite quantum states, the composite quantum states entangled within each other;
monitoring execution of the requested workflow for problems within the determined workflow components;
detecting a problem within a workflow component during execution of the workflow request;
changing composite quantum state associated with the detected problem in the workflow component, the changed composite quantum state reflected in the each of the determined workflow components; and
providing an alarm to a workflow processing platform and determined workflow components.

11. The method of claim 10, further comprising:
stopping execution of the workflow request in real-time based on the changed composite quantum state.

12. The method of claim 10, further comprising:
determining workflow components associated with additional workflows, the determined workflow components used in both the additional workflows and the requested workflow.

13. The method of claim 12, further comprising:
determining logic points and associated states within each determined additional workflow component that effect other determined workflow components associated with the additional workflows.

14. The method of claim 13, further comprising:
transforming the determined associated states within each determined additional workflow component into composite quantum states.

15. The method of claim 10, further wherein the requested workflow comprises a credit workflow.

16. The method of claim 15, further wherein the requested credit workflow includes an underwriting component, a fulfillment component, a servicing component, and a monitoring component.

17. The method of claim 10, further wherein the requested workflow comprises an account opening workflow.

18. The method of claim 10, wherein the requested workflow comprises a digital wallet provisioning workflow.

19. One or more non-transitory computer-readable media storing instructions that, when executed by a computing platform comprising at least one processor, and memory, cause the computing platform to:
receive, a workflow request;
determine workflow components associated with the received workflow request;
determine logic points and associated states within each determined workflow component associated with the received workflow request that effect other determined workflow components associated with the workflow request;
transform the determined associated states within each determined workflow component into composite quantum states, the composite quantum states entangled within each other;
monitor execution of the requested workflow for problems within the determined workflow components;
detect a problem within a workflow component during execution of the workflow request;
change composite quantum state associated with the detected problem in the workflow component, the changed composite quantum state reflected in the each of the determined workflow components; and
provide an alarm to a workflow processing platform and determined workflow components.

20. The one or more non-transitory computer-readable media storing instructions of claim 19, wherein the instructions comprise additional computer-readable instructions that, when executed by the at least one processor, cause the computing platform to stop execution of the workflow request in real-time based on the changed composite quantum state.
